(19) United States
(12) Patent Application Publication
(10) Pub. No.: US 2021/0373225 A1
(43) Pub. Date: Dec. 2, 2021

(54) REFLECTIVE DISPLAY DEVICE AND FRONT LIGHT SOURCE MODULE THEREOF

(71) Applicant: Sichuan Longhua Film Co., Ltd., Mianyang (CN)

(72) Inventors: PO-HUNG YAO, HSINCHU CITY (TW); YAO-CHANG WANG, Zhubei City (TW)

(21) Appl. No.: 17/329,192

(22) Filed: May 25, 2021

(30) Foreign Application Priority Data
Jun. 1, 2020 (CN) 202010484281.8

(51) Int. Cl. F21V 8/00

(52) U.S. Cl. CPC G02B 6/0043; G02B 6/0073

(57) ABSTRACT

A front light source module includes a light guide assembly and a light source assembly. The light guide assembly includes a light guide body and optical microstructures. The light guide body includes a first optical surface, a second optical surface and a light incident surface. The first optical surface and the second optical surface are opposed to each other. The light incident surface is connected between the first optical surface and the second optical surface. The first optical surface is close to a viewer side. The optical microstructures are formed on at least one of the first optical surface and the second optical surface. Each optical microstructure has an inclined side surface relatively inclined to one of the first optical surface and the second optical surface. The light source assembly is disposed beside the light incident surface. A reflective display device having the front light source module is also provided.

### FIELD OF THE INVENTION

The present invention relates to a display device, and more particularly to a reflective display device and a front light source module thereof.

### BACKGROUND OF THE INVENTION

With the development and promotion of the 5th generation (5G) mobile networks or the 5G communication technology, the ultra-high-speed communication has opened the door to imaginative applications for a large number of wireless data transmissions, and the corresponding information receiving and display devices also enter the era of technical requirements for ultra-high resolution and low power consumption. It is expected that the convenience of information transmission will greatly increase the time of using the display device. In order to achieve both low power consumption and improved eye protection for long-term viewing of display panel, the technological development of the new generation of reflective display panel-related components has become an important subject.

Different from the traditional direct light display panels (e.g., LCD, OLED, MicroLED, etc.), the reflective display panels are similar to the light reflection characteristics of paper, and have the characteristics of high visibility in sunlight, power saving, and lightness. However, the non-self-luminous reflective panel may greatly reduce the visibility of the panel in an environment without external light source. Therefore, how to provide a stable source of illumination for reflective panels without affecting the display screen will be a key element that determines whether reflective panel products can be applied and popularized in the future.

### SUMMARY OF THE INVENTION

The present invention provides a reflective display device and a front light source module thereof, which can avoid the situation in which the image presented by the reflective display device has low brightness and poor contrast, thereby improving the environmental adaptability of the reflective display device.

The front light source module provided by the present invention is applied to a reflective display device and includes a light guide assembly and a light source assembly. The light guide assembly includes a light guide body and a plurality of optical microstructures. The light guide body includes a first optical surface, a second optical surface and at least one light incident surface. The first optical surface and the second optical surface are opposed to each other. The at least one light incident surface is connected between the first optical surface and the second optical surface. The first optical surface is close to a viewer side. The plurality of optical microstructures is formed on at least one of the first optical surface and the second optical surface. Each of the plurality of optical microstructures has at least one inclined side surface, and the inclined side surface is relatively inclined to one of the first optical surface and the second optical surface. The light source assembly is disposed beside the at least one light incident surface.

In an embodiment of the present invention, the plurality of optical microstructures is formed on the first optical surface, and an angle between the inclined side surface and the first optical surface is between 10 degrees and 90 degrees.

In an embodiment of the present invention, the plurality of optical microstructures is formed on the second optical surface, and an angle between the inclined side surface and the second optical surface is between 10 degrees and 90 degrees.

In an embodiment of the present invention, the plurality of optical microstructures is convex structures, concave structures, or a combination thereof. The convex structure has a cone shape, a pyramid shape, a trapezoid-like shape, a polygon shape, or a combination thereof. A concave contour of the concave structure has an inverted cone shape, a chamfered pyramid shape, a trapezoid-like shape, a polygonal shape, or a combination thereof.

In an embodiment of the present invention, a maximum structure width of the convex structure is between 2 μm and 40 μm, and a structure height of the convex structure is between 0.05 times and 2.5 times of the maximum structure width. A maximum structure width of the concave structure is between 2 μm and 40 μm, and a structural depth of the concave structure is between 0.05 times and 2.5 times of the maximum structure width.

In an embodiment of the present invention, the inclined side surface is undulating.

In an embodiment of the present invention, the light guide body is formed by a single polymer material or a layered combination of two or more polymer materials, and an optical haze of the light guide body is not greater than 25%.

In an embodiment of the present invention, the plurality of optical microstructures has different distribution densities on the light guide body, wherein, the farther the area from the light source assembly is, the higher the distribution density of the optical microstructures.

In an embodiment of the present invention, the light source assembly includes at least one LED element. In one embodiment, the light source assembly further includes a light angle convergent element disposed between the LED element and the at least one light incident surface.

In an embodiment of the present invention, the light guide body and the plurality of optical microstructures are integrally formed with a plastic material.

In an embodiment of the present invention, the light guide body includes a plastic base layer and a colloid layer. The colloid layer is disposed on the plastic base layer, and the plurality of optical microstructures is formed on the colloid layer.

In an embodiment of the present invention, the light guide assembly further includes a functional plating layer conformally covering the plurality of optical microstructures and the first optical surface and/or the second optical surface where the plurality of optical microstructures is formed.

The reflective display device provided by the present invention includes a display panel and the aforementioned front light source module. The front light source module is disposed on the display panel. The second optical surface of the front light source module faces the display panel.

In an embodiment of the present invention, there is an air barrier between the second optical surface and the display panel.

In an embodiment of the present invention, there is a transparent adhesive medium layer between the second optical surface and the display panel, and a refractive index of the transparent adhesive medium layer is between 1.2 and 1.7.

In an embodiment of the present invention, the illumination beam incident through the at least one light incident surface is sequentially transmitted and reflected in the light guide assembly and exits to the display panel through the second optical surface. Part of the illuminating beam is reflected by the display panel as an image beam, and the image beam passes through the light guide assembly and exits through the first optical surface to the viewer side.

In an embodiment of the present invention, the aforementioned reflective display device further includes a transparent conductive layer and a transparent conductive pattern layer. The transparent conductive layer is disposed on one of the first optical surface and the second optical surface, and the transparent conductive pattern layer is disposed on the other one of the first optical surface and the second optical surface.

In an embodiment of the present invention, the aforementioned reflective display device further includes at least one retardation optical layer disposed between the display panel and the light guide assembly or between the light guide assembly and the viewer side.

The present invention achieves the image presentation of the display panel by the reflection of the illumination beam of the front light source module. In addition, because the light guide assembly of the front light source module has the optical microstructures, the illumination beam emitted to the display panel is distributed within a specific range of the exit angle. As such, when the external light source environment is insufficient, the situation in which the image presented by the reflective display device has low brightness and poor contrast can be avoided, thereby improving the environmental adaptability of the reflective display device.

### BRIEF DESCRIPTION OF THE DRAWINGS

The present invention will become more readily apparent to those ordinarily skilled in the art after reviewing the following detailed description and accompanying drawings, in which:

FIG. 1 is a schematic cross-sectional structure diagram of a reflective display device according to an embodiment of the present invention;

FIGS. 2A to 2C are schematic diagrams of the concave structures on part of the light guide body in different configurations of the embodiments of the present invention;

FIGS. 3A to 3C are schematic diagrams of the convex structures on part of the light guide body in different configurations of the embodiments of the present invention;

FIG. 4 is a schematic diagram of the optical microstructure on part of the light guide body according to another embodiment of the present invention;

FIG. 5 is a schematic cross-sectional structure diagram of a light guide assembly according to an embodiment of the present invention;

FIG. 6 is a schematic cross-sectional structure diagram of a light guide assembly according to another embodiment of the present invention;

FIG. 7 is a schematic cross-sectional structure diagram of a reflective display device according to another embodiment of the present invention; and

FIG. 8 is a schematic cross-sectional structure diagram of a reflective display device according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

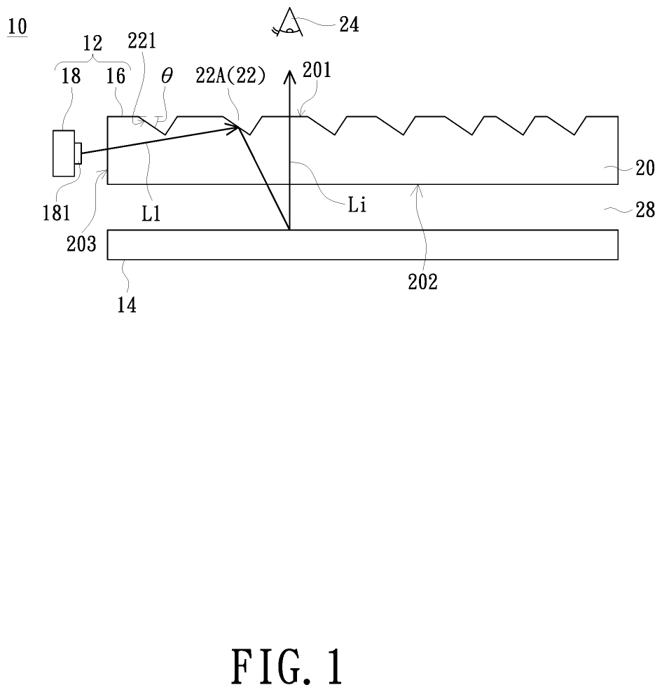

FIG. 1 is a schematic cross-sectional structure diagram of a reflective display device according to an embodiment of the present invention. As shown in FIG. 1, the reflective display device 10 includes a front light source module 12 and a display panel 14. The front light source module 12 is disposed on the display panel 14. The front light source module 12 includes a light guide assembly 16 and a light source assembly 18. The light guide assembly 16 includes a light guide body 20 and a plurality of optical microstructures 22. The light guide body 20 is, for example, in the shape of a plate and has a first optical surface 201, a second optical surface 202 and a light incident surface 203. The first optical surface 201 and the second optical surface 202 are opposed to each other, and the light incident surface 203 is connected between the first optical surface 201 and the second optical surface 202. In one embodiment, the first optical surface 201 is close to the viewer 24 above, and the second optical surface 202 faces the display panel 14. The optical microstructures 22 are formed on at least one of the first optical surface 201 and the second optical surface 202. Each optical microstructure 22 has an inclined side surface 221. The inclined side surface 221 is relatively inclined to the first optical surface 201 or the second optical surface 202 on which the optical microstructures 22 are formed. Preferably, the inclined side surface 221 faces the light incident surface 203. In the embodiment shown in FIG. 1, the optical microstructure 22 is formed on the first optical surface 201, for example, and there is an angle θ between the inclined side surface 221 of the optical microstructure 22 and the first optical surface 201, wherein the angle θ is between 10 degrees and 90 degrees. The distribution characteristics of the light-emitting angle of the light guide assembly 16 can be adjusted by selecting the angle of the angle θ, but the invention is not limited thereto. In an embodiment not shown, the optical microstructures 22 can be formed on the second optical surface 202, or on both the first optical surface 201 and the second optical surface 202. When the optical microstructure 22 is formed on the second optical surface 202, the angle between the inclined side surface 221 of the optical microstructure 22 and the second optical surface 202 can also be between 10 degrees and 90 degrees.

Please continue to refer to FIG. 1. The light source assembly 18 is disposed beside the light incident surface 203. The illumination beam L1 emitted by the light source assembly 18 sequentially enters the light guide assembly 16 through the light incident surface 203, and is transmitted in the light guide assembly 16, and is reflected by the inclined side surfaces 221 of the microstructures 22, and exits to the display panel 14 through the second optical surface 202. In one embodiment, the optical microstructures 22 have different distribution densities on the light guide body 20. Specifically, the farther the area from the light source assembly 18 is, the higher the distribution density of the optical microstructures 22 is. Therefore, by the different distribution densities of the optical microstructures 22, the illumination beam L1 can uniformly exit from the second optical surface 202, and most of the emitted illumination beam L1 is distributed within a specific exit angle range.

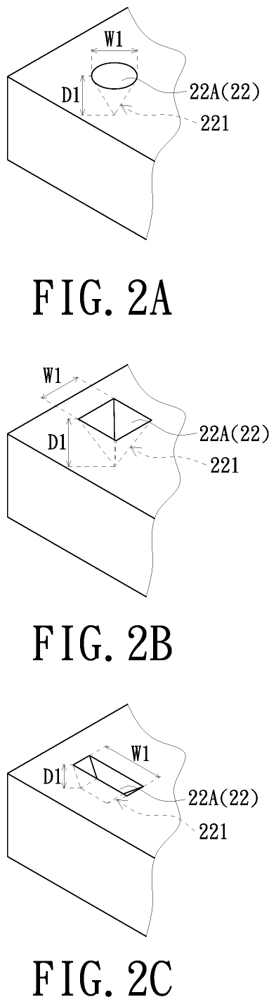

The optical microstructure 22 may be a concave structure 22A, a convex structure 22B, or a combination of the concave structure 22A and the convex structure 22B. Preferably, the optical microstructure 22 is a concave structure 22A. The concave structure 22A is, for example, a pit-shaped concave structure, and the convex structure 22B is, for example, a granular convex structure. As shown in FIG. 1, a plurality of concave structures 22A is formed on the first optical surface 201. FIGS. 2A to 2C are schematic diagrams of the concave structures on part of the light guide body in different configurations of the embodiments of the present invention. As shown in FIG. 2A, the concave contour of the concave structure 22A is in the shape of an inverted cone, and the side surface of the inverted cone shape is used as the inclined side surface 221 of the optical microstructure 22. In an embodiment not shown, the concave contour of the concave structure 22A may be a truncated inverted cone. As shown in FIG. 2B, the concave contour of the concave structure 22A is in the shape of a chamfered pyramid, for example, in the shape of an inverted quadrangular pyramid, and the side surface of the chamfered pyramid is used as the inclined side surface 221 of the optical microstructure 22. In an embodiment not shown, the concave contour of the concave structure 22A may be a truncated chamfered pyramid shape. As shown in FIG. 2C, the concave contour of the concave structure 22A is a trapezoid-like shape, and the side surface of the trapezoid-like shape is used as the inclined side surface 221 of the optical microstructure 22. However, the invention does not limit the shape of the concave structure 22A, and the concave contour of the concave structure 22A can be other polygonal shapes in other embodiments. In addition, the shapes of the concave contours of the concave structures 22A on the first optical surface 201 or the second optical surface 202 may be the same or different.

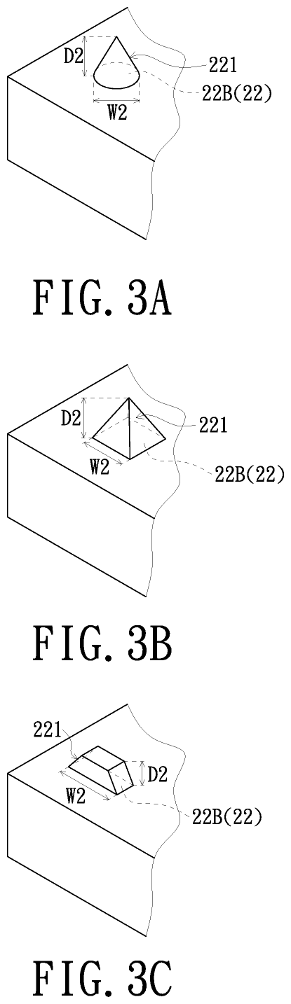

FIGS. 3A to 3C are schematic diagrams of the convex structures on part of the light guide body in different configurations of the embodiments of the present invention. As shown in FIG. 3A, the convex structure 22B is in the shape of a cone, and the side surface of the cone shape is used as the inclined side surface 221 of the optical microstructure 22. In an embodiment not shown, the convex structure 22B may be a truncated cone. As shown in FIG. 3B, the convex structure 22B is in the shape of a chamfered pyramid, for example, in the shape of a quadrangular pyramid, and the side surface of the chamfered pyramid is used as the inclined side surface 221 of the optical microstructure 22. In an embodiment not shown, the convex structure 22B may be a truncated chamfered pyramid shape. As shown in FIG. 3C, the convex structure 22B is a trapezoid-like shape, and the side surface of the trapezoid-like shape is used as the inclined side surface 221 of the optical microstructure 22. However, the invention does not limit the shape of the convex structure 22B, and the convex structure 22B can be other polygonal shapes in other embodiments. In addition, the shapes of the convex structures 22B on the first optical surface 201 or the second optical surface 202 may be the same or different, or, the first optical surface 201 or the second optical surface 202 may be formed with the same or different convex structures 22B and the same or different concave structures 22A at the same time.

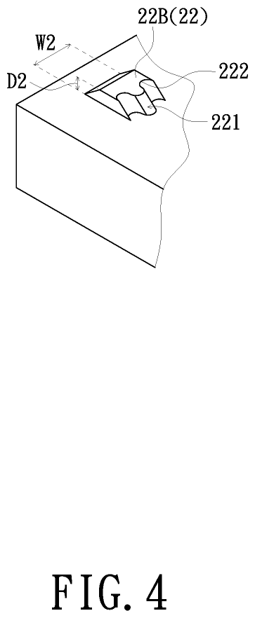

The inclined side surface 221 is not limited to a flat surface. FIG. 4 is a schematic diagram of the optical microstructure on part of the light guide body according to another embodiment of the present invention. Taking the optical microstructure 22 as the convex structure 22B as an example, as shown in FIG. 4, the top side of the convex structure 22B has a curved ridge line 222, and the inclined side surface 221 undulates along the curved ridge line 222.

As shown in FIGS. 2A to 2C, in the above-mentioned different configurations of the embodiments of the optical microstructure 22, the maximum structure width W1 of the concave structure 22A is between 2 μm and 40 μm, and the structure depth D1 of the concave structure 22A is between 0.05 times and 2.5 times of the maximum structure width W1. As shown in FIGS. 3A to 3C and 4, the maximum structure width W2 of the convex structure 22B is between 2 μm and 40 μm, and the structure height D2 of the convex structure 22B is between 0.05 times and 2.5 times of the maximum structure width W2. The maximum structure widths W1 and W2 are defined as the maximum horizontal dimensions of the three-dimensional optical microstructure 22, and the structure depth D1 and the structure height D2 are defined as the vertical height of the three-dimensional optical microstructure 22.

Please continue to refer to FIG. 1. The light source assembly 18 includes an LED element 181. The illumination beam L1 generated by the LED element 181 enters the light guide assembly 16 through the light incident surface 203 and is reflected to the second optical surface 202 through the inclined side surface 221. In addition, the light source assembly 18 may further include a light angle convergent element (not shown), which is disposed between the light exit side of the LED element 181 and the light incident surface 203 of the light guide body 20. The light angle convergent element may be a micro lens group, the light guide pipe and the micro-cylindrical lens array to adjust the angular distribution of the illumination beam L1 of the LED element 181 before the illumination beam L1 enters the light guide assembly 16.

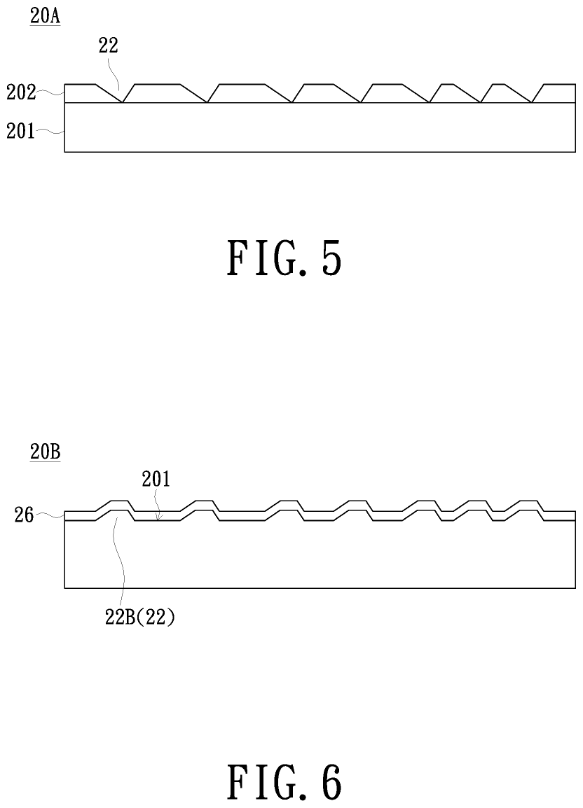

The light guide body 20 can be formed by a single polymer material or a layered combination of two or more polymer materials, and the optical haze of the light guide body 20 is not greater than 25%. In one embodiment, the light guide assembly 16 has high transparency. As shown in FIG. 1, the light guide body 20 and the optical microstructures 22 are integrally formed with a plastic material, such as polycarbonate (PC). FIG. 5 is a schematic cross-sectional structure diagram of a light guide assembly according to an embodiment of the present invention. As shown in FIG. 5, the light guide body 20A may include a plastic base layer 201 and a colloid layer 202. The material of the plastic base layer 201 is, for example, polycarbonate. The colloid layer 202 is disposed on the plastic base layer 201, and the optical microstructures 22 are formed on the colloid layer 202. The refractive index of the plastic base layer 201 is, for example, 1.59, and the refractive index of the colloid layer 202 is, for example, 1.38 to 1.72.

FIG. 6 is a schematic cross-sectional structure diagram of a light guide assembly according to another embodiment of the present invention. As shown in FIG. 6, the light guide assembly 20B further includes a functional plating layer 26. The functional plating layer 26 conformally covers the optical microstructures 22 and the first optical surface 201 where the optical microstructures 22 are formed, so as to achieve the effects of scratch resistance, anti-reflection and anti-glare. In the embodiment shown in FIG. 6, the optical microstructure 22 is a convex structure 22B as an example, but the invention is not limited thereto.

Please continue to refer to FIG. 1. In one embodiment, there is an air barrier 28 between the second optical surface 202 and the display panel 14. In an embodiment not shown, there may be a transparent adhesive medium layer between the second optical surface 202 and the display panel 14, and the refractive index of the transparent adhesive medium layer is between 1.2 and 1.7. As shown in FIG. 1, the illuminating beam L1 incident from the light incident surface 203 exits to the display panel 14 through the second optical surface 202. Part of the illuminating beam L1 is reflected by the display panel 14 into an image beam Li. The image beam Li passes through the light guide assembly 16 and exits to the viewer 24 through the first optical surface 201. In the embodiment of the present invention, the image presentation of the display panel 14 can be achieved by the reflection of the illumination beam L1 of the front light source module 12. As such, when the external light source environment is insufficient, the situation in which the image presented by the reflective display device 10 has low brightness and poor contrast can be avoided, thereby improving the environmental adaptability of the reflective display device 10.

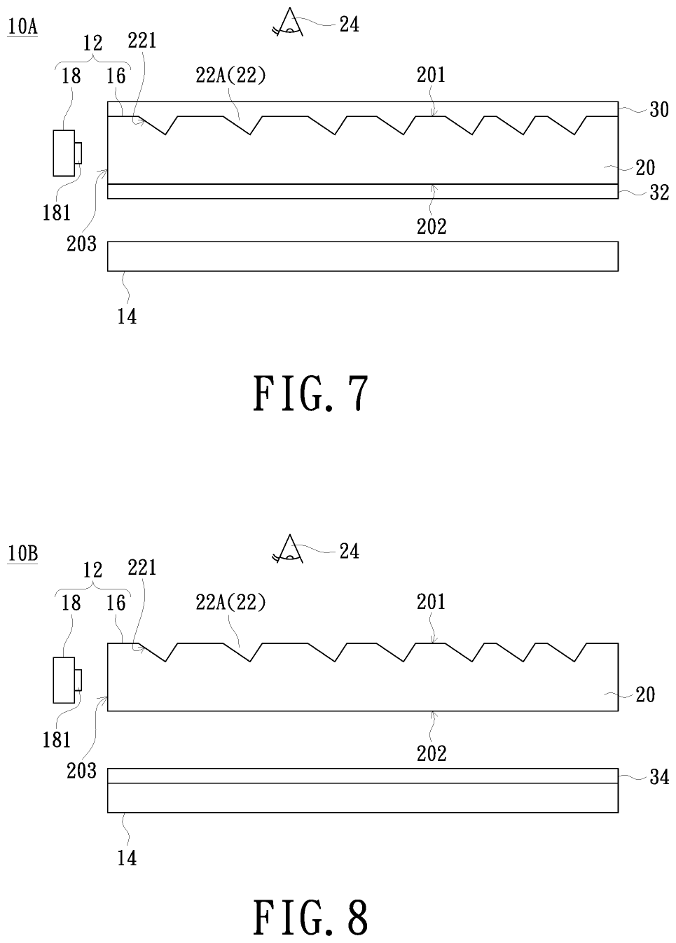

FIG. 7 is a schematic cross-sectional structure diagram of a reflective display device according to another embodiment of the present invention. As shown in FIG. 7, the main difference between the reflective display device 10A shown in FIG. 7 and the reflective display device 10 shown in FIG. 1 is that the reflective display device 10A further includes a transparent conductive layer 30 and a transparent conductive pattern layer 32. The transparent conductive layer 30 is disposed on one of the first optical surface 201 and the second optical surface 202, and the transparent conductive pattern layer 32 is disposed on the other one of the first optical surface 201 and the second optical surface 202. In the embodiment shown in FIG. 7, the transparent conductive layer 30 is, for example, disposed on the first optical surface 201, and the transparent conductive pattern layer 32 with a coded pattern design is disposed on the second optical surface 202, so that the reflective display device 10A is with touch function.

FIG. 8 is a schematic cross-sectional structure diagram of a reflective display device according to another embodiment of the present invention. As shown in FIG. 8, the main difference between the reflective display device 10B shown in FIG. 8 and the reflective display device 10 shown in FIG. 1 is that the reflective display device 10B further includes at least one retardation optical layer 34 disposed between the display panel 14 and the light guide assembly 16 or/and between the light guide assembly 16 and the viewer 24. In the embodiment shown in FIG. 8, the retardation optical layer 34 is, for example, disposed between the light guide assembly 16 and the display panel 14. In one embodiment, the retardation optical layer 34 is, for example, a quarter wave plate, and therefore the reflective display device 10B is suitable for use by a viewer 24 wearing sunglasses.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A front light source module, applied to a reflective display device, the front light source module comprising:
a light guide assembly, comprising a light guide body and a plurality of optical microstructures, wherein
the light guide body comprises a first optical surface, a second optical surface and at least one light incident surface, the first optical surface and the second optical surface are opposed to each other, the at least one light incident surface is connected between the first optical surface and the second optical surface, and the first optical surface is close to a viewer side; and
the plurality of optical microstructures is formed on at least one of the first optical surface and the second optical surface, each of the plurality of optical microstructures has at least one inclined side surface, and the inclined side surface is relatively inclined to one of the first optical surface and the second optical surface; and
a light source assembly, disposed beside the at least one light incident surface.

2. The front light source module according to claim 1, wherein the plurality of optical microstructures is formed on the first optical surface, and an angle between the inclined side surface and the first optical surface is between 10 degrees and 90 degrees.

3. The front light source module according to claim 1, wherein the plurality of optical microstructures is formed on the second optical surface, and an angle between the inclined side surface and the second optical surface is between 10 degrees and 90 degrees.

4. The front light source module according to claim 1, wherein the plurality of optical microstructures is convex structures, concave structures, or a combination thereof.

5. The front light source module according to claim 4, wherein the convex structure has a cone shape, a pyramid shape, a trapezoid-like shape, a polygon shape, or a combination thereof.

6. The front light source module according to claim 4, wherein a concave contour of the concave structure has an inverted cone shape, a chamfered pyramid shape, a trapezoid-like shape, a polygonal shape, or a combination thereof.

7. The front light source module according to claim 4, wherein a maximum structure width of the convex structure is between 2 μm and 40 μm, and a structure height of the convex structure is between 0.05 times and 2.5 times of the maximum structure width.

8. The front light source module according to claim 4, wherein a maximum structure width of the concave structure is between 2 μm and 40 μm, and a structural depth of the concave structure is between 0.05 times and 2.5 times of the maximum structure width.

9. The front light source module according to claim 1, wherein the inclined side surface is undulating.

10. The front light source module according to claim 1, wherein an optical haze of the light guide body is not greater than 25%.

11. The front light source module according to claim 1, wherein the light source assembly comprises at least one LED element.

12. The front light source module according to claim 11, wherein the light source assembly further comprises a light angle convergent element disposed between the LED element and the at least one light incident surface.

13. The front light source module according to claim 1, wherein the light guide body and the plurality of optical microstructures are integrally formed with a plastic material.

14. The front light source module according to claim 1, wherein the light guide body comprises a plastic base layer and a colloid layer, the colloid layer is disposed on the plastic base layer, and the plurality of optical microstructures is formed on the colloid layer.

15. The front light source module according to claim 1, wherein the light guide assembly further comprises a functional plating layer conformally covering the plurality of optical microstructures and the first optical surface and/or the second optical surface where the plurality of optical microstructures is formed.

16. A reflective display device, comprising:
a display panel; and
a front light source module, disposed on the display panel and comprising:
a light guide assembly, comprising a light guide body and a plurality of optical microstructures, wherein
the light guide body comprises a first optical surface, a second optical surface and at least one light incident surface, the first optical surface and the second optical surface are opposed to each other, the at least one light incident surface is connected between the first optical surface and the second optical surface, and the first optical surface is close to a viewer side; and
the plurality of optical microstructures is formed on at least one of the first optical surface and the second optical surface, each of the plurality of optical microstructures has at least one inclined side surface, and the inclined side surface is relatively inclined to one of the first optical surface and the second optical surface; and
a light source assembly, disposed beside the at least one light incident surface,
wherein the second optical surface of the front light source module faces the display panel.

17. The reflective display device according to claim 16, wherein there is an air barrier between the second optical surface and the display panel.

18. The reflective display device according to claim 16, wherein there is a transparent adhesive medium layer between the second optical surface and the display panel, and a refractive index of the transparent adhesive medium layer is between 1.2 and 1.7.

19. The reflective display device according to claim 16, further comprising a transparent conductive layer and a transparent conductive pattern layer, wherein the transparent conductive layer is disposed on one of the first optical surface and the second optical surface, and the transparent conductive pattern layer is disposed on the other one of the first optical surface and the second optical surface.

20. The reflective display device according to claim 16, further comprising at least one retardation optical layer disposed between the display panel and the light guide assembly or between the light guide assembly and the viewer side.
